(19) United States
(12) Patent Application Publication
(10) Pub. No.: US 2014/0057055 A1
(43) Pub. Date: Feb. 27, 2014

(54) System and Method for Using an Electrostatic Tool

(71) Applicant: Finishing Brands Holdings Inc., Minneapolis, MN (US)

(72) Inventors: Steven Andrew Myers, Scottsdale, AZ (US); Payton Xavier Cozart, Toledo, OH (US)

(73) Assignee: Finishing Brands Holdings Inc., Minneapolis, MN (US)

(21) Appl. No.: 13/966,178

(22) Filed: Aug. 13, 2013

Related U.S. Application Data
(60) Provisional application No. 61/692,670, filed on Aug. 23, 2012.

(51) Int. Cl. B05B 5/00

(52) U.S. Cl. CPC B05B 5/005
USPC 427/458; 239/690; 239/700

(57) ABSTRACT

A system, including an electrostatic spray system, including an electrostatic tool configured to spray a material with an electrostatic charge, and a controller and wherein the controller is configured to change modes of the electrostatic tool, and wherein the modes are different processes that change the rate of material discharge, how much electrical charge is applied to the material, and when electrical charge is applied to the material.

### CROSS REFERENCE TO RELATED APPLICATION

This application claims priority to and benefit of U.S. Provisional Patent Application No. 61/692,670 entitled “SYSTEM AND METHOD FOR USING AN ELECTROSTATIC TOOL”, filed Aug. 23, 2012, which is herein incorporated by reference in its entirety.

### BACKGROUND

The invention relates generally to system and method for using an electrostatic tool.

Electrostatic tools spray electrically charged materials to more efficiently coat objects. For example, electrostatic tools may be used to paint objects. In operation, a grounded target attracts electrically charged materials sprayed from an electrostatic tool. As the electrically charged material contacts the grounded target, the material loses the electrical charge. Different materials lose electrical charges at different rates. Accordingly, some materials may not lose their electrical charge before more electrically charged material contacts the target. These residual charges may interfere with the overall coating and product finishes.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, an electrostatic spray system, including an electrostatic tool configured to spray a material with an electrostatic charge, and a controller and wherein the controller is configured to change modes of the electrostatic tool, and wherein the modes are different processes that change the rate of material discharge, how much electrical charge is applied to the material, and when electrical charge is applied to the material.

In another embodiment, a system including an electrostatic tool controller configured to change operating modes of an electrostatic tool that discharges electrically charged material with slow rates of electrical charge decay.

In another embodiment, a method for producing a part with an electrostatic spray system, including powering an electrostatic tool with a power source, electrically charging a material, spraying the material with the electrostatic tool, changing the electric charge on the material while spraying, and discontinue spraying the material.

In another embodiment, a method for producing a part with an electrostatic spray system, including powering an electrostatic tool with a power source, electrically charging a material, spraying the electrically charged material with the electrostatic tool, gradually reducing the amount of electrically charged material sprayed, and discontinue spraying the material.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of an electrostatic spray system;

FIG. 2 is a flowchart of an exemplary method for using the electrostatic spray system of FIG. 1;

FIG. 3 is a flowchart of an exemplary method for using the electrostatic spray system of FIG. 1;

FIG. 4 is a flowchart of an exemplary method for using the electrostatic spray system of FIG. 1;

FIG. 5 is a flowchart of an exemplary method for using the electrostatic spray system of FIG. 1; and

FIG. 6 is a flowchart of an exemplary method for using the electrostatic spray system of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed towards an electrostatic system and methods for using the same. Specifically, the electrostatic system may fabricate products and coat objects using material with slow electrical charge decay (i.e., materials that once electrically charged do not easily lose charge). The slow electrical charge decay may interfere with proper product finishes and tolerances as the material starts to repel itself. The methods/processes described below advantageously enable an electrostatic system to fabricate products and coat objects using materials that have slow charge decay. For example, some of the embodiments described below may change the amount of electrical charge added to the sprayed material over time (i.e., periodically increase and decrease the electrical charge). This may advantageously allow the material to lose electrical charge by adding little or no charge for periods of time. In other embodiments, the electrostatic system may change the amount of sprayed material, thus giving the material more time to lose electrical charge by adding less overall charge to the coating or product.

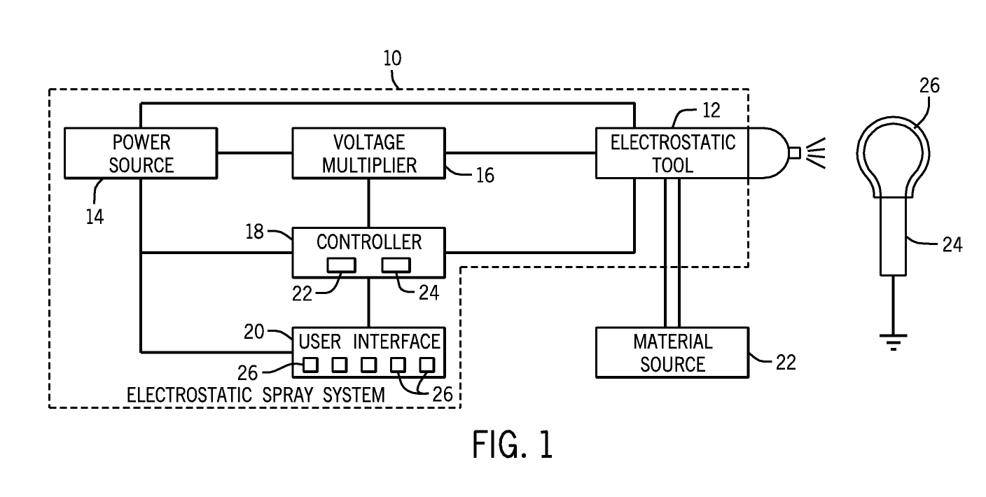

FIG. 1 is a schematic of an electrostatic spray system 10 that may use different processes to coat or produce products (implantable medical devices, syringe needles, stents, guide wires, catheters, etc.), with polymer materials that have slow rates of charge decay (silicon, polyethylene terephtalate (PET), low density polyethylene (LDPE), polyethylene films, etc.). Unfortunately, liquid silicon, among other polymer materials, may have a slow rate of electrical charge decay that can create poor finishes, because the material retains charge that may then repel additional material. Advantageously, the electrostatic spray system 10 may change the electric charge on the sprayed material over a period of time (e.g., periodically add less charge, remove all charge). The change in electric charge allows the material a period of time to lose electric charge (i.e., charge decay). The system 10 may also change how much charged material is sprayed. That is by spraying less material over a period of time less charge is added overall allowing the material to lose charge. The ability to change electric charge and change the amount of sprayed material enables system 10 to produce medical products with the proper finishes and tolerances. Accordingly, in accordance with the discussed embodiments, the electrostatic spray system may advantageously use different processes to produce products (e.g., medical products) with the proper finishes and tolerances using materials that have slow rates of electrical charge decay. The electrostatic spray system 10 includes an electrostatic tool 12, a power source 14, voltage multiplier 16, controller 18, and user interface 20. In operation, the electrostatic spray system 10 is configured to electrically charge and spray a material from material source 22. This material is sprayed onto a grounded target 24 (e.g., a mandrel) that electrically attracts the charged material due to the charge. As the material collects on the target 24, it may form a product 26 or a coating.

In operation, the electrostatic spray system 10 uses the power source 14 to power an electrostatic tool 12. The electrostatic tool 12 may be a rotary atomizer or air atomizer capable of providing particle size less 10, 15, 20, 25, 50, 75, 100, 150, 200, or 250 microns (e.g., approximately between 1-20 microns, 3-18 microns, 5-15 microns). In operation, the electrostatic tool 12 electrically charges, atomizes, and sprays the material from the material source 22. The material may be a material used in medical products (e.g., a polymer, liquid silicon) or another kind of material with a slow electrical charge decay.

In the illustrated example, the electrostatic spray system 10 uses the voltage multiplier 16 to electrically charge the material inside the electrostatic tool 12. The voltage multiplier 16 receives power from the power source 14. The power source 14 may include an external power source or an internal power source, such as an electrical generator. The voltage multiplier 16 receives power from the power source 14 and converts the power to a higher voltage to be applied to the material in the electrostatic tool 12. More specifically, the voltage multiplier 16 may apply power to the material with a voltage between approximately 5 kV and 100 kV or greater. For example, the power may be at least approximately 15, 25, 35, 45, 55, 65, 75, 85, 95, 100, kV. As will be appreciated, the voltage multiplier 16 may be removable and may include diodes and capacitors. In certain embodiments, the voltage multiplier 16 may also include a switching circuit that changes the power between a positive and a negative voltage.

As shown in FIG. 1, the electrostatic spray system 10 includes the controller 18 and user interface 20, each of which may be powered by the power source 14. As illustrated, the controller 18 includes a processor 22 and a memory 24. The memory 24 may store instructions (i.e., software code) executable by the processor 22 to control operation of the electrostatic spray system 10. The controller 18 may be coupled to the voltage multiplier 16 and the electrostatic tool 12 to monitor various operating parameters and conditions. For example, the controller 18 may execute instructions to monitor and control the voltage from the voltage multiplier 16. Similarly, the controller 18 may execute instructions to monitor and control the power from the power source 14. Furthermore, the controller 18 may execute instructions to monitor and control the actual voltage applied to the material in the electrostatic tool 12.

The user interface 20 connects to and receives information from the controller 18. In certain embodiments, the user interface 20 may be configured to allow a user to adjust various settings and operating parameters based on information collected by the controller 18. Specifically, the user may adjust settings or parameters with a series of buttons or knobs 26 coupled to the user interface 20. In certain embodiments, the user interface 34 may include a touch screen that enables both user input and display of information relating to the electrostatic spray system 10. For example, the user interface 20 may enable a user to adjust the voltage supplied by the voltage multiplier 16, turn the voltage on/off, and adjust the amount of material sprayed by the tool 12 using a knob, dial, button, or menu on the user interface 34. Moreover, the user interface 34 may include preprogrammed operating modes for an electrostatic spray system 10. These modes may be processes that change the electric charge added to a sprayed material over a period of time or that change the amount of material sprayed by the electrostatic system 10. The modes may include periodically adding and completely removing electric charge from a sprayed material; progressively increasing and decreasing electric charge on sprayed material; removing all charge from material at an end portion of a spraying cycle; gradually reducing the electric charge on the sprayed material to nothing; or changing the amount of electrically charged material that is sprayed. An operator may activate one or more modes using a button, knob, dial, or menu 26 on the user interface 34. These preprogrammed modes may be a specific process for manufacturing a product, a specific step in a process, or may correspond to operating parameters for the electrostatic spray system 10 (e.g., voltage level, material discharge rate, time).

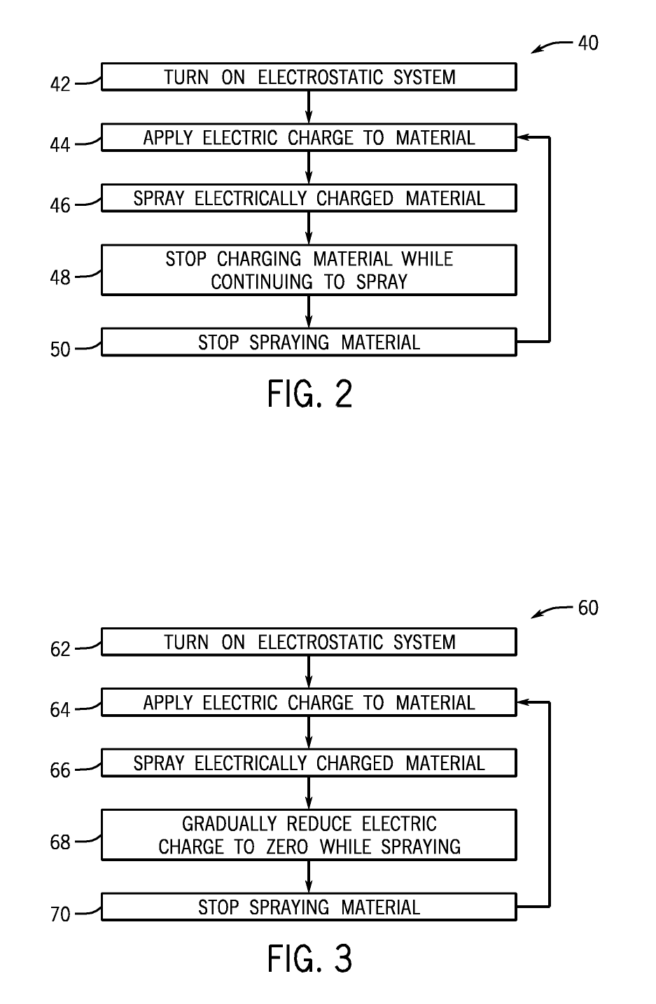

FIG. 2 is a flowchart of an exemplary method or process 40 for using or operating the electrostatic spray system of FIG. 1. This process 40 may advantageously remove electric charge from a sprayed material at an end portion of the spraying process to allow electric charge to dissipate. Thus enabling fabrication of a product (e.g., medical product) with the proper finishes and tolerances using a material with a slow electrical charge decay rate. The process 40 begins by turning on the electrostatic system 10. Once the electrostatic system 10 turns on, a user may interact with the user interface 20 to select a particular operating mode or operating parameters for the system 10. For example, a user may select a mode that runs process 40 for making a medical product or applying a coating. The user may also select specific operating parameters for process 40 (e.g., voltage level, amount of material to be sprayed, time period for applying voltage, etc.). The controller 18 receives this information from the user interface 20 and uses the information to operate the system 10. Specifically, the controller 18 uses the processor 22 to execute instructions contained in the memory 24.

After receiving instructions from the controller 18, the electrostatic tool 12 applies an electric charge to material from the material source 22, represented by step 44. The electric charge will be specific to the mode (i.e., positive or negative charge and approximately between 5-100 kV). In the next step, the electrostatic tool 12 begins spraying the electrically charged material at a target (e.g., a mandrel), represented by step 46. As explained above, some materials once electrically charged do not lose charge quickly; that is, they have a slow rate of electrical charge decay. Accordingly, the material already on the object 24 may repel freshly sprayed electrically charged material, creating poor finishes or improper tolerances.

Advantageously, the process 40 allows the excessive electrical charge to dissipate. Specifically, electrostatic tool 12 may stop charging material while continuing to spray, represented by step 48. The process step 48 therefore sprays electrical neutral material, on top of electrically charged material on the mandrel 24. By spraying electrical neutral material the electrically charged material on the mandrel 24 has an opportunity to lose some or all of its electrical charge. The electrical charge may decay by traveling to ground through the mandrel, dissipating into the freshly sprayed electrically neutral material, and/or traveling through the air to the grounded electrostatic tool 12. The decay in electric charge reduces the ability of the material already on the target to repel the freshly sprayed material, therefore producing a product or coating with the proper finish and tolerance. Moreover, the time period for executing the step in step 48 may change depending on how fast the material loses electrical charge. For example, step 48 may last approximately 1 second to 100 or more seconds (e.g., 1-5, 3-10, 5-15, 10-100 seconds). The time period may be user adjustable, or auto adjustable based on feedback from electrical charge flowing through the target (e.g., mandrel). The process 40 may then stop spraying material, represented by step 50. Depending on the product or coating, the process 40 may repeat itself after a specific time period (e.g., flash period or partial cure period). For example, the process 40 may repeat multiple times (e.g., 1, 2, 3, 4, 5, 10, 15, 20 or more times) before producing a finished product or coating. Again, each iteration of the process 40 may first apply the electrically charged material (block 46) followed by applying the material without a charge to improve the top finish of the coating(s).

FIG. 3 is a flowchart of an exemplary method or process 60 for using the electrostatic spray system 10 of FIG. 1. The process 60 may advantageously gradually reduce electric charge to zero while spraying to allow electric charge to dissipate. Thus enabling fabrication of a product (e.g., medical product) with the proper finishes and tolerances using a material with a slow electrical charge decay rate. The process 60 begins by turning on the electrostatic system 10, represented by step 62. The user then selects the particular operating mode that runs process 60 and the associated operating parameters (e.g., voltage level, amount of material to be sprayed, how long will voltage be applied, etc.) using the interface 20. The controller 18 receives this information from the user interface 20 and uses the information to operate the system 10. Specifically, the controller 18 uses the processor 22 to execute instructions contained in the memory 24.

After receiving instructions from the controller 18, the electrostatic tool 12 applies electric charge to material coming from the material source 22, represented by step 64. The electric charge may be specific to the mode (i.e., positive or negative charge and approximately between 5-100 kV). The electric charge may be user adjustable, tied to the mode, and/or auto adjustable. The process 60 then begins spraying the electrically charged material using the electrostatic tool 12, represented by step 66. As explained above, some materials once electrically charged do not lose charge quickly; that is, they have a slow rate of electrical charge decay. Accordingly, the material already on the target 24 may repel freshly sprayed electrically charged material, creating poor finishes or improper tolerances.

Advantageously, the process 60 allows the excessive electrical charge to dissipate. Specifically, the electrostatic tool 12 may gradually reduce the electric charge applied to the material to zero over a period of time, represented by step 68. The rate at which the electrostatic tool 12 changes the electric charge depends on the material's ability to lose electrical charge. For example, if the material sprayed takes a long time to lose electrical charge, then the electrostatic tool may rapidly reduce the amount of electrical charge imparted to the material. For materials that may dissipate electric charge more quickly the rate may be slower (i.e., the electrostatic tool 12 may slowly reduce the amount of charge added to the material being sprayed). The process step 68, therefore, enables the material to lose electrical charge by reducing the amount of additional electrical charge over time. The decay in electrical charge may, therefore, reduce the ability of the applied material to repel, additional material thereby improving the finish and/or tolerances. As explained above, the electrical charge may decay by traveling to ground through the mandrel, dissipating into the freshly sprayed material that contains less electrical charge, and/or traveling through the air to the grounded electrostatic tool 12. The process 60 may then stop spraying material, represented by step 70. Depending on the product or coating, the process 60 may repeat after a specific time period (e.g., flash period or partial cure period). For example, the process 60 may repeat multiple times (e.g., 1, 2, 3, 4, 5, 10, 15, 20 or more times) before producing a finished product or coating.

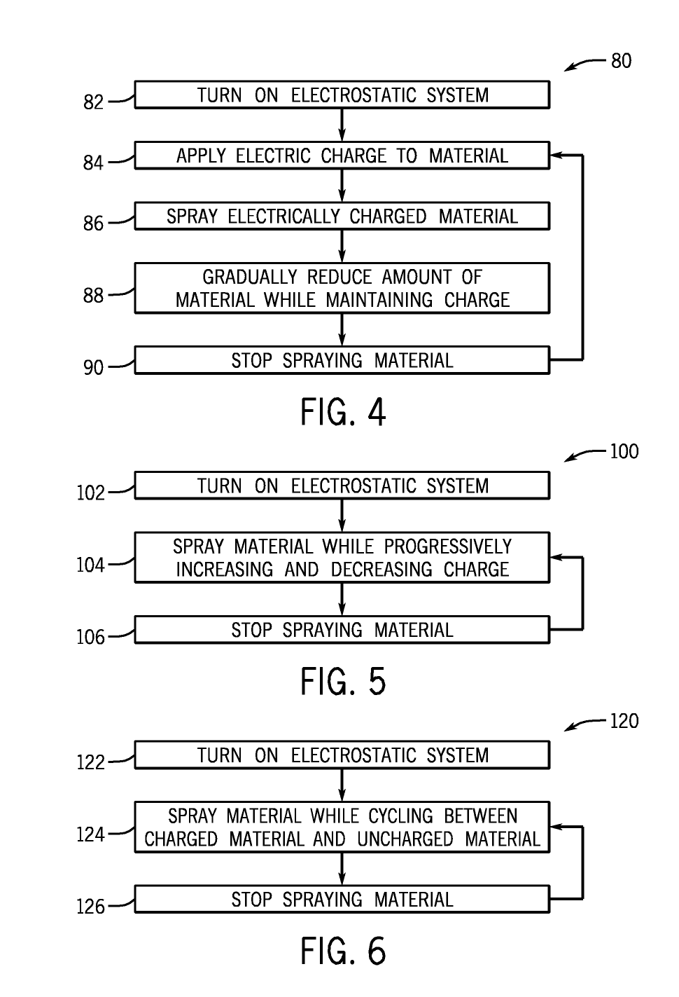

FIG. 4 is a flowchart of an exemplary method 80 for using the electrostatic spray system 10 of FIG. 1. This process 80 may advantageously gradually spray less electrically charged material to allow electric charge to dissipate. Thus enabling fabrication of a product (e.g., medical product) with the proper finishes and tolerances using a material with a slow electrical charge decay rate. The process 80 begins by turning on the electrostatic system 10, represented by step 82. The user then selects the particular operating mode that runs process 80 and the associated operating parameters (e.g., voltage level, amount of material to be sprayed, how long voltage will be applied, etc.) using the interface 20. The controller 18 receives this information from the user interface 20 and then executes instructions stored in the memory 24 to operate the system 10.

After receiving instructions from the controller 18, the electrostatic tool 12 applies electric charge to material coming from the material source 22, represented by step 84. The electric charge will be specific to the mode (i.e., positive/negative charge and approximately between 5-100 kV). The process 80 then begins spraying the electrically charged material using the electrostatic tool 12, represented by step 86. As explained above, some materials once electrically charged do not lose charge quickly and may repel freshly sprayed electrically charged material, creating poor finishes or improper tolerances. Advantageously, the process 80 allows the electrical charge to dissipate while adding limited amounts of additional electric charge. Specifically, in step 88 of the process 80, the system 10 gradually reduces the amount of material sprayed over time while maintaining the electric charge on the material being sprayed. Accordingly, by spraying less material less charge is added over time, thus enabling the charge to decay. As the charge decays, the applied material is less likely to repel additional material and, therefore, produces an improved finish and/or tolerance. The process 80 may then stop spraying material, represented by step 90. Depending on the product or coating, the process 80 may repeat after a specific time period (e.g., flash period or partial cure period). For example, the process 80 may repeat multiple times (e.g., 1, 2, 3, 4, 5, 10, 15, 20 or more times) before producing a finished product or coating.

FIG. 5 is a flowchart of an exemplary method 100 for using the electrostatic spray system 10 of FIG. 1. This process 100 may advantageously increase and decrease electric charge on the sprayed material, allowing the material to lose electric charge during periods when the sprayed material has less electrical charge. Thus enabling fabrication of a product (e.g., medical product) with the proper finishes and tolerances using a material with a slow electrical charge decay rate. The process 100 begins by turning on the electrostatic system 10, represented by step 102. The user then selects the particular operating mode that runs process 100 and the associated operating parameters (e.g., voltage level, amount of material to be sprayed, how long voltage will be applied, how quickly the voltage will increase or decrease, etc.) using the interface 20. The controller 18 receives this information from the user interface 20 and then executes instructions stored in the memory 24 to operate the system 10.

After receiving instructions from the controller 18, the electrostatic tool 12 adds an electric charge to a material as it sprays the material. The electric charge will be specific to the mode (i.e., positive/negative charge and approximately between 5-100 kV). More specifically, the electrostatic tool 12 will progressively increase and progressively decrease the charge on the sprayed material, represented by step 104. For example, the controller 18 may direct the electrostatic tool 12 to increase the voltage on the material from 5 to 100 kV over a period of time (e.g., 1, 2, 3, 4, 5, 10, 15, 20, 25, 30, or more seconds) and to then decrease the voltage from 100 to 5 kV over another time period (e.g., 1, 2, 3, 4, 5, 10, 15, 20, 25, 30 or more seconds). The time period may be user adjustable, or auto adjustable based on feedback from electrical charge flowing through the target (e.g., mandrel). Furthermore, the controller 18 may direct the electrostatic tool 12 to repeat this step 104 multiple times (e.g., 1, 2, 3, 4, 5, 10, 20, 30 or more times). As explained above, when the material retains charge, it negatively affects the finish or tolerances of the final coating or product by repelling freshly sprayed material. Advantageously, the process 100 allows the electrical charge to dissipate during periods when the electrostatic tool 112 applies less electric charge to the sprayed material. Accordingly, by alternating or periodically increasing and decreasing the charge on the sprayed material, the charge on the material is able to decay so that the applied material does not repel additional material, thereby improving the finish and/or tolerance. The process 100 may then stop spraying material, represented by step 106. Depending on the product or coating, the process 100 may repeat after a specific time period (e.g., flash period or partial cure period). For example, the process 100 may repeat itself multiple times (e.g., 1, 2, 3, 4, 5, 10, 15, 20 or more times) before producing a finished product or coating.

FIG. 6 is a flowchart of an exemplary method 120 for using the electrostatic spray system 10 of FIG. 1. This process 120 may advantageously remove all electric charge and then add electric charge during the spraying process to allow the electric charge to dissipate. Thus enabling fabrication of a product (e.g., medical product) with the proper finishes and tolerances using a material with a slow electrical charge decay rate. The process 120 begins by turning on the electrostatic system 10, represented by step 122. The user then selects the particular operating mode that runs process 120 and the associated operating parameters (e.g., voltage level, amount of material to be sprayed, how long voltage will be applied, etc.) using the interface 20. The controller 18 receives this information from the user interface 20 and then executes instructions stored in the memory 24 to operate the system 10.

After receiving instructions from the controller 18, the electrostatic tool 12 adds an electric charge to a material as it sprays the material. The electric charge will be specific to the mode (i.e., positive/negative charge and approximately between 5-100 kV). More specifically, the electrostatic tool 12 will cycle between adding charge and removing all charge from the sprayed material, represented by step 124. For example, the controller 18 may execute instructions that direct the electrostatic tool 12 to add a voltage to the sprayed material between 5-100 kV for a specific period of time (e.g., 1, 2, 3, 4, 5, 10, 15, 20, 25, 30 or more seconds) and to then remove all charged on the sprayed material for another time period (e.g., 1, 2, 3, 4, 5, 10, 15, 20, 25, 30 or more seconds). The time period may be user adjustable, or auto adjustable based on feedback from electrical charge flowing through the target (e.g., mandrel). Depending on the embodiment, the time period of spraying charged material may shorter or longer than the time period for spraying uncharged material. As explained above, if the material does not lose the added charge quickly the remaining charge may negatively affect the finish or tolerances of the final coating or product by repelling freshly sprayed material. Advantageously, the process 120 allows the electrical charge to dissipate by cycling between spraying electrically charged material followed by uncharged material in order to produce a coating or product with the proper finish and/or tolerances. The process 120 may then stop spraying material, represented by step 126. Depending on the product or coating the process 120 may repeat itself after a specific time period (e.g., flash period or partial cure period). For example, the process 120 may repeat multiple times (e.g., 1, 2, 3, 4, 5, 10, 15, 20 or more times) before producing a finished product or coating.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic spray system, comprising:
an electrostatic tool configured to spray a material with an electrostatic charge; and
a controller and wherein the controller is configured to change modes of the electrostatic tool, and wherein the modes are different processes that change the rate of material discharge, how much electrical charge is applied to the material, and when electrical charge is applied to the material.

2. The system of claim 1, wherein the controller includes a processor.

3. The system of claim 2, wherein the controller includes a memory, and wherein the memory is configured to store instructions for use by the processor that allow the controller to change operating modes of the electrostatic tool.

4. The system of claim 1, wherein the electrostatic tool is a rotary atomizer

5. The system of claim 1, wherein the material is liquid silicon.

6. The system of claim 1, wherein the controller is part of the electrostatic tool.

7. The system of claim 1, wherein the electrostatic tool includes a voltage multiplier.

8. The system of claim 1, wherein the electrostatic tool includes a user interface configured to allow a user to change the modes.

9. A system comprising:
an electrostatic tool controller configured to change operating modes of an electrostatic tool that discharges electrically charged material with slow rates of electrical charge decay.

10. The system of claim 9, wherein the controller includes a processor.

11. The system of claim 10, wherein the controller includes a memory with instructions for the processor, and wherein the instructions include different operating modes for the electrostatic tool.

12. The system of claim 9, wherein the controller is configured to change an electric charge of the material discharged by the electrostatic tool.

13. The system of claim 9, wherein the controller is configured to change an amount of material discharged by the electrostatic tool.

14. The system of claim 9, wherein the controller is configured to remove an electric charge from the material while the electrostatic tool is spraying the material.

15. A method for producing a part with an electrostatic spray system, comprising:
powering an electrostatic tool with a power source;
electrically charging a material;
spraying the material with the electrostatic tool;
changing the electric charge on the material while spraying; and
discontinue spraying the material.

16. The method of claim 15, wherein the step changing the electric charge on the material while spraying includes removing all electrical charge before discontinuing to spray the material.

17. The method of claim 15, wherein the step changing the electric charge on the material while spraying includes gradually reducing the electric charge on the material to zero.

18. The method of claim 15, wherein the step changing the electric charge on the material includes progressively increasing and progressively decreasing the electric charge on the material.

19. The method of claim 15, wherein the step changing the electric charge on the material includes cycling between charging the material to a threshold level of electric charge and then removing the electric charge.

20. A method for producing a part with an electrostatic spray system, comprising:
powering an electrostatic tool with a power source;
electrically charging a material;
spraying the electrically charged material with the electrostatic tool;
gradually reducing the amount of electrically charged material sprayed; and
discontinue spraying the material.
